(19) United States
(12) Patent Application Publication
(10) Pub. No.: US 2004/0169490 A1
(43) Pub. Date: Sep. 2, 2004

(54) Power supply device for a motor-driven blind or similar

(76) Inventor: Arnaud Heurtault, Groisy (FR)

Correspondence Address: Ronald R Santucci, Frommer Lawrence & Haug, 745 Fifth Avenue, New York, NY, 10151, US

(21) Appl. No.: 10/480,185

(22) PCT Filed: Jun. 17, 2002
(86) PCT No.: PCT/FR02/02085

(30) Foreign Application Priority Data
Jun. 20, 2001 (FR) 01/08096

(51) Int. Cl. H02J 7/00

(52) U.S. Cl. 320/114

(57) ABSTRACT

A power supply device for a motor-driven blind or similar (1), which is not connected to a network by means of electric wiring, characterized in that it comprises a detachable power supply device (5) consisting of an autonomous power supply (12) and detachable electric connection means enabling said detachable power supply device (5) to be connected to and disconnected from the blind.

The invention relates to a power supply device for a motorized solar protection device, such as an awning or a roller blind. It is more particularly pertinent to a power supply device allowing an awning motor to be supplied with power in the absence of a power cable.

Solar protection devices of the motorized awning type are now widely used in dwellings, stores or businesses, over pavements outside restaurants or cafes, and other applications. These awnings consist of a fabric connected to a winding tube driven in rotation by an electric motor so as to unwind or wind up said fabric.

Such awnings are generally installed on the outside wall of a building shortly after it has been completed, without a suitable power cable being provided at the time of construction. Since we are dealing with walls made of solid masonry, it will be understood that it is a problem to provide electrical ducting through them.

Such awnings are also placed, for example, over pavements outside cafes or public areas. Here again, their electrical operation requires bringing in unsightly or dangerous cables. In the latter case, storage batteries and a low-voltage DC motor are sometimes used. These storage batteries are often recharged by solar panels.

Utility model DE 200.00.681 discloses, for example, an embodiment in which the photovoltaic elements are placed along the loading bar of the awning.

Also known, from French patent application published under number 2 661 210, is an awning whose motor may be supplied by a removable power supply, but this power supply is only an emergency power supply, and the awning is therefore connected to the mains via a power cable. That device therefore does not solve the problems that the device of the invention intends to solve.

However, it is a shame to have available a complex and expensive installation while the power sockets connected to the AC mains are generally accessible a short distance away, often only a few meters, from the awning to be actuated.

Thus, according to the invention, the power supply device for a motorized awning or the like not connected to the mains via a power cable, is characterized in that it consists of a removable power supply device comprising an autonomous power supply and electrical connection means for connecting said removable power supply device to said awning and for disconnecting it therefrom.

According to a complementary feature, the form of the power supply device is that of a rod or elongate case, the upper part of which includes the electrical connection means.

It should be pointed out that the autonomous power supply is placed in the lower part of the removable power supply device.

According to a preferred embodiment of the invention, said power supply is of the rechargeable type, such as a battery or a supercapacitor.

According to other complementary features, the device includes, in its upper part, mechanical means for mechanically fastening said device to the awning, and for unfastening it.

The invention also relates to the awning intended to be supplied by the device, which awning is of the type consisting of a fabric connected via one of its borders to a winding tube driven in rotation about its general axis by an electric motor, while it includes a box, one of the ends of which has complementary connection means intended to cooperate with the connection means of the removable power supply device.

According to a preferred embodiment of the invention, the electric motor is coupled to a speed converter device operating as chopper amplifier.

Other features and advantages of the invention will become clear from the description that follows, together with the appended drawings that are given merely as non-limiting examples.

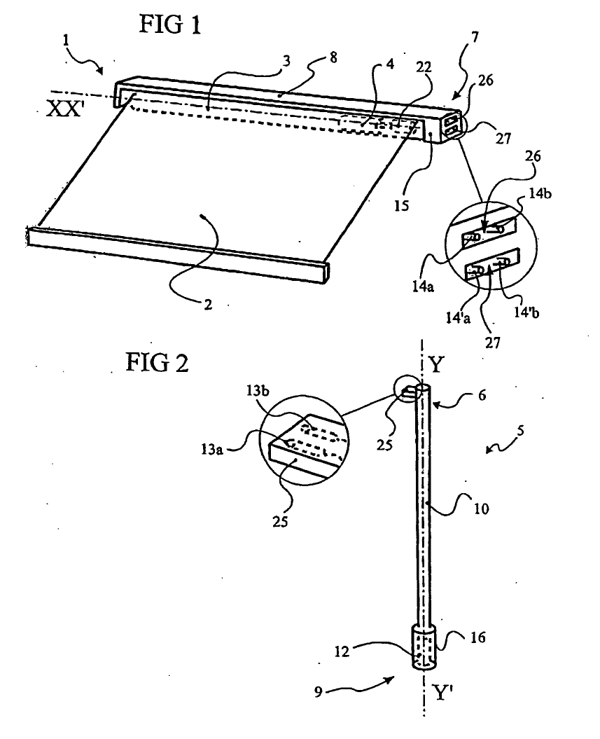

FIG. 1 shows a solar protection awning at rest, without its motor being supplied with power.

FIG. 2 shows the removable power supply device alone, disconnected from the awning.

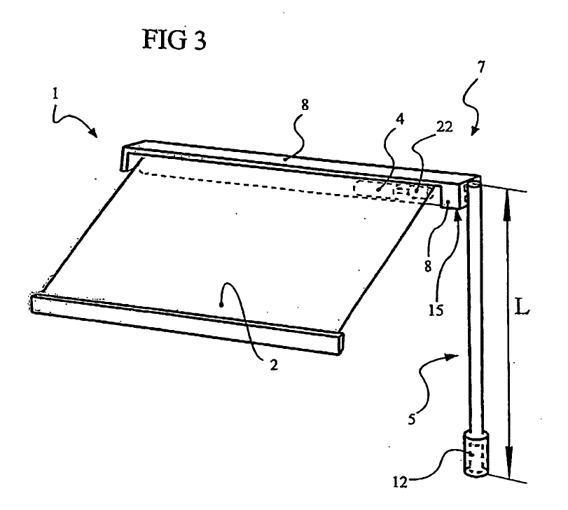

FIG. 3 illustrates the awning with its power supply provided by the removable power supply device connected at the end of the box.

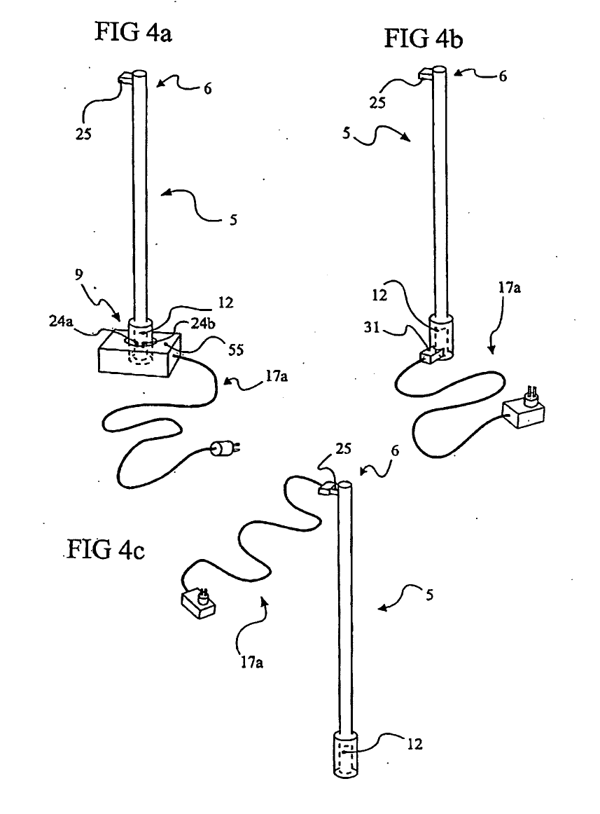

FIGS. 4a, 4b, 4c are schematic views illustrating the removable power supply device with various possible charges given as examples.

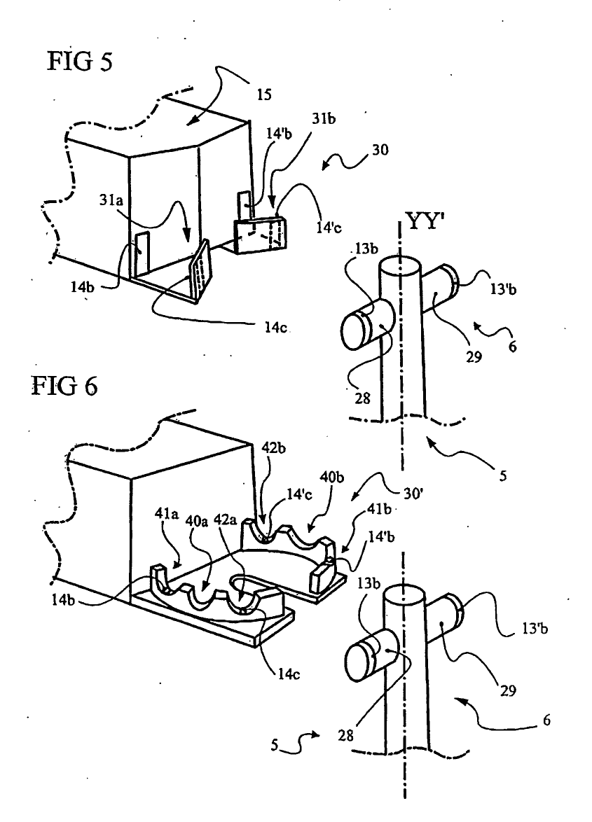

FIG. 5 illustrates an embodiment of a removable connection between the power supply device and the awning.

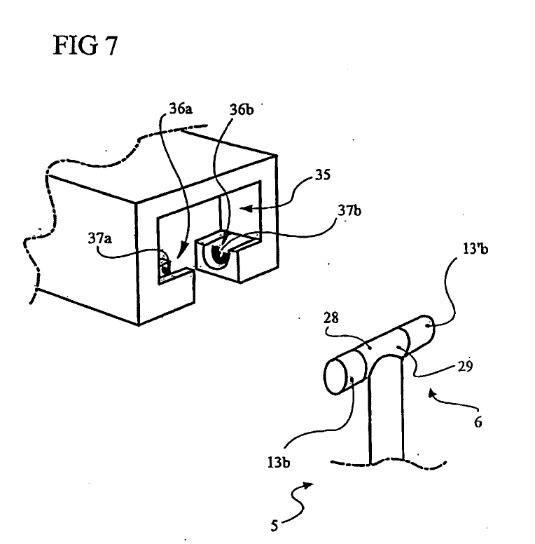

FIGS. 6 and 7 illustrate two other embodiments of a removable mechanical and electrical connection between the power supply device and the awning.

The invention will be described in the case of a solar protection awning, and is more particularly suited to this type of device but could just as well be used with a roller blind without in any way departing from the scope of the invention.

The solar protection device (1), illustrated by way of example in FIG. 1 and FIG. 2, and intended to be electrically powered by the means according to the invention, is of the awning type consisting of a fabric (2) connected via one of its borders to a winding tube (3) driven in rotation about its general axis (X, X′) by an electric motor (4) advantageously placed inside the winding tube like, for example, that described in the prior French patent published under number 2 780 748.

The tube can be made to undergo a rotational movement about itself by means of the electric motor (4), either in order to completely or partly wind up the fabric around its periphery, so as to place the awning in a fully or partly retracted position, or to unwind it, so as to deploy the fabric, thus placing the awning in an active, full or partial, protection position.

It should be noted that the awning of the invention is not connected to the mains via a power cable and that the power supply device of the invention constitutes its only power supply, the electric motor of the awning being only supplied by the power supply device of the invention. The power supply of the invention is therefore not an emergency power supply, but constitutes the principle supply since the awning is not connected to the mains.

The power supply device of the awning (1) according to the invention is an autonomous removable power supply device (5) that can be moved between a storage position (FIG. 2), in which the device is separated from the awning, and an active position (FIG. 3), in which the device is connected to the awning. Of course, if the device (5) includes rechargeable batteries, the storage position is advantageously a charging position (FIGS. 4a, 4b, 4c). It should also be noted that, in the active position, the electrical connection is provided permanently, as illustrated in FIGS. 2 and 7, or intermittently, as shown schematically in FIGS. 5 and 6.

The removable power supply device (5) consists of an elongate supply case in the form of a rod (10) that includes, in its upper part (6), means for a mechanical and electrical connection of the awning, and more particularly to one of the ends (7) of its box (8).

Moreover, the supply rod (10) also includes the power supply needed to supply the electric motor (4) of the awning.

This power supply is autonomous and is a cell or advantageously a rechargeable-type electrical storage element (12) such as a battery, which is designed to allow a limited number, for example two or four, of successive maneuvers so as to reduce its size and its weight.

The removable power supply device (5) then includes, for example at its lower part (9), one or more rechargeable batteries or cells (12) housed in a battery case (16) that extends the rod (10) at its lower part.

The battery or batteries are recharged in a manner known per se by means of a charger (17) designed to be connected to the mains supplied with AC current, which may be of any type. FIGS. 4a, 4b, 4c show three embodiments of this charger, given by way of example.

According to the embodiment illustrated in FIG. 4a, the charger (17a), consists of a charger base (55) intended to receive the lower part (9) of the power supply device (9) that includes the appropriate recharging connections (24a-24b).

According to the embodiment illustrated in FIG. 4b, the charger (17b) is a conventional charger intended to be connected to the corresponding charging socket (31) of the removable power supply device (5).

According to the embodiment illustrated in FIG. 4c, the charger (17c) is suitable for being connected to the power supply device (5) via its electrical connection placed in its upper part, which connection will be described in the next paragraph.

Connection means are provided for removably connecting the removable power supply device (5) to the electrical circuit of the motor (4). For this purpose, said circuit is connected to an end box case (15) and said connection means consist, on the one hand, of electrical connection means for electrical linkage between the battery (12) and the electrical circuit of the motor and, on the other hand, of mechanical connection means for mechanical retention and attachment of the removable power supply device (5), which may in certain cases remain attached, hanging down at the end of the box.

According to the embodiment illustrated in FIGS. 1 and 2, the electrical connection means also constitute the mechanical connection means. They are formed by the cooperation of the electrical contacts (13a-13b) produced in the upper part (6) of the removable power supply device (5) with corresponding electrical contacts (14a-14b, 14′a-14′b) which are placed in the end box case (15) and are connected to the electrical circuit of the motor (4). According to this embodiment, the motor (4) is connected directly to the electrical contacts (14a-14b, 14′a-14′b) and includes end-of-travel switches, while the removable power supply device (5) has neither switch nor electrical inverter. In this case, the user takes the removable power supply device (5), after having recharged it with the appropriate charger (17), and hangs it in its position at the end of the box, which action automatically makes the electrical connection. Depending on the position of the removable power supply device (5) in its housing, the motor will cause the awning to be wound up or unwound, and the motor will stop operating either upon removal of the removable power supply device (5) or because the end of travel has been reached. In this case, the removable power supply device (5) may remain without inconvenience in its housing, without any problem, until the opposite maneuver.

In the embodiment described above, the upper part (6) of the rod (10) is provided with a lateral connection projection (25) that includes the electrical power supply contacts (13a, 13b), said projection being designed to fit into a corresponding reception housing (26, 27) made at the end of the box and including the corresponding electrical contacts (14a-14b, 14′a-14′b) of the electrical circuit of the motor. Thus, according to this embodiment, provided at the end of the box are two housings—a first housing (26) including first electrical contacts (14a-14b) and a second housing (27) including second electrical contacts (14′a-14′b)— for receiving the removable power supply device (5), the first housing (26) corresponding to the electrical contacting that causes the awning to be unwound, whereas the second housing (27) corresponds to the electrical contacting that causes the awning to be wound up. When the user wishes to operate his awning, he will then choose the corresponding connection housing in order to connect his power supply rod (5, 10)—the first housing (26) for unwinding the awning and the second housing (27) for winding it up.

In the embodiment described above, the two housings (26-27) are placed one above the other, but they could be placed otherwise. Thus, the first housing (26) could be provided at one of the ends of the box, while the second housing (27) would be placed at the other end.

It should be added that the lower part of the removable device may also constitute the means of gripping it by the user.

According to another embodiment, the removable power supply device (5) may be provided with an inverter switch, advantageously in its lower part, which also constitutes the abovementioned gripping means.

According to one embodiment, the electric motor (4) is coupled to a converter device (22) operating, for example, as a chopper amplifier. This device (22) is known per se and makes it possible either to increase the operating voltage, such as for example to supply a 12-volt motor by means of a power supply of only 3 volts or to compensate for the gradual drop in voltage of the storage battery as it discharges. In the case of coupling the motor (4) to the converter device (22), the connection means placed at the upper part of the removable power supply device (5) would then include polarization means in order to ensure constant polarities at the inlet of the electronic device and at least a third wire, from a switch, indicating the direction of rotation.

To allow the electrical storage element (12) to be very rapidly recharged, there is provision to use a supercapacitor, which makes it possible, moreover, to store sufficient energy in a limited volume while allowing several operations, and to do so by recharging in a very short time. With a charging voltage of 3 volts, it would be possible to obtain a capacitance of 3500 farads in a volume of less than one cubic decimeter.

It will have been understood that the removable power supply device (5) has an elongate shape similar to the conventional manual handle generally used. The device also has a length (L) of between 70 and 170 centimeters and can be put into place at any time for the purpose of operating the awning.

FIG. 5 illustrates an alternative embodiment of the connection between the awning (1) and the removable power supply device (5, 10).

According to this alternative embodiment, the winding and unwinding operation will be initiated by the pivoting of the rod about its longitudinal axis (Y, Y′). Thus, the upper part (6) of the rod (10) includes two lateral catching and connection projections (28, 29), while the end of the box includes a cradle (30) for receiving the end of the rod, said cradle being designed to receive the lateral attachment and connection projections. The receiving cradle (30) is intended to retain the upper part of the power supply device and to provide the contacts needed for supplying power to the electrical circuit of the motor. Thus, it includes, for example, two attachment hooks (31a, 31b) and the electrical contacts (14b-14′c, 14′b-14c) for electrical connections, these being intended to cooperate with the corresponding electrical contacts (13b, 13′b) of the upper part of the rod. To actuate his awning, the user will have to attach the end of the rod in the cradle (30) at the end of the box and make the rod pivot about its axis (Y, Y′), in one direction or in the other, in order to bring either the electrical contacts (14c-14′b) for the winding operation or the electrical contacts (14b, 14′c) for the unwinding operation into contact with the corresponding contacts (13b, 13′b) of the power supply device (5).

FIG. 6 illustrates another embodiment of the connection between the awning (1) and the removable power supply device (5, 10).

According to this other embodiment, like the previous one, the winding and unwinding command will be effected by pivoting of the rod about its longitudinal axis (Y, Y′). Thus, the upper part (6) of the rod (10) includes two lateral attachment and connection projections (28, 29), while the end of the box includes a cradle (30′) for receiving the end of the rod, said cradle being intended to receive the lateral attachment and connection projections. For this purpose, the receiving cradle (30′) is intended to retain the upper part of the power supply device and provide the contacts needed to supply power to the electrical circuit of the motor. Thus, it includes, for example, two curved side walls, each comprising a succession of three receiving recesses, it being understood that the diametrically opposed central recesses (40a-40b) constitute the rest position of the device and that the other two recesses (41a-41b), these two being diametrically opposed, are provided with electrical contacts (14b-14′c) for winding up the awning, whereas the other recesses (42a-42b) include electrical contacts (14c-14′c) for unwinding the awning. It will have been understood that the user will need only to pivot his rod about its rest position into one of the pivoted positions in order for the lateral projections (28, 29) of the device (5) to be either placed in the wind-up recesses (41a-41b), the wind-up contacts (14b-14′b) of which will be brought into contact with the power supply contacts (13b-13′b), or placed in the unwind recesses (42a-42b), the unwind contacts (14c-14′c) of which will be brought into contact with the power supply contacts (13b-13′b), which will cause either the awning to be wound up or unwound, respectively.

Another alternative embodiment is illustrated in FIG. 7. In this embodiment, the end (15) of the awning box includes a receiving housing (35) constituting dish-shaped receiving seats (36a, 36b), each including an electrical contact (37a, 37b) connected to the electrical circuit of the motor. To operate the motor, the user will attach the end arm of the rod (38), said arm being formed by the lateral attachment projections (28, 29) which are each equipped with a contact connected to the power supply (12). Depending on the direction of attachment, one or other of the directions of operation will be actuated. To switch from one direction to the other, the user will have to lift the rod up and pivot it through 180° in order to reattach it and thus reverse the direction of operation.

According to the embodiments described above, the power supply (12) of the power supply device is housed in a case placed in the lower part of said device, but it could be placed in any other position such as, for example housed in the upper part (6) or in a region between the upper end and the lower end of the rod.

It should be added that the device described above has the overall shape of a straight tube, but it could also be of any other form. Thus, it would be possible for the rod body not to be straight but, for example, partly or completely curved, and could have any shape of cross section, whether constant or varying. Moreover, the end of the device could also have the form of a hook, without thereby departing from the scope of the invention.

Of course, the invention is not limited to the embodiments described and shown by way of examples, rather it also includes all technical equivalents and their combinations.

1. A power supply device for a motorized awning or the like (1) not connected to the mains via a power cable, characterized in that it consists of a removable power supply device (5) comprising an autonomous power supply (12) and electrical connection means for connecting said removable power supply device (5) to said awning (1) and for disconnecting it therefrom.

2. The power supply device for a motorized awning or the like (1) as claimed in claim 1, characterized in that the form of the removable power supply device (5) is that of a rod or elongate case (10), the upper part (6) of which includes the connection means.

3. The power supply device for a motorized awning or the like (1) as claimed in claim 2, characterized in that the rod or elongate case (10) has a length (L) of between 70 and 170 centimeters.

4. The power supply device for a motorized awning or the like (1) as claimed in one of claims 1 to 3, characterized in that the autonomous power supply (12) is placed in the lower part (9) of the removable power supply device (5).

5. The power supply device for a motorized awning or the like (1) as claimed in any one of the preceding claims, characterized in that the autonomous power supply (12) is of the rechargeable type.

6. The power supply device for a motorized awning or the like (1) as claimed in claim 5, characterized in that the autonomous power supply (12) is a supercapacitor.

7. The power supply device for a motorized awning or the like (1) as claimed in one of the preceding claims, characterized in that it includes, at its upper part (6), mechanical means allowing it to be fastened to the motorized awning.

8. A motorized awning intended to be supplied by the device as claimed in any one of the preceding claims, characterized in that it is of the type consisting of a fabric (2) connected via one of its borders to a winding tube (3) driven in rotation about its general axis (X, X′) by an electric motor (4).

9. The motorized awning as claimed in claim 8, characterized in that it includes a box (8), one of the ends (7) of which has complementary connection means intended to cooperate with the connection means of the removable power supply device (5).

10. The motorized awning as claimed in claim 9, characterized in that the electric motor (4) is coupled to a converter device (22) operating as chopper amplifier.
